(19) United States
(12) Patent Application Publication
(10) Pub. No.: US 2003/0193684 A1
(43) Pub. Date: Oct. 16, 2003

(54) Method and system for diagnosing printing defects

(76) Inventors: David R. Kendall, Bosie, ID (US); Tony Barrett, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/119,650

(22) Filed: Apr. 10, 2002

(51) Int. Cl. G06K 15/02; G06F 15/00; G06F 11/30; H04N 1/409

(52) U.S. Cl. 358/1.14; 382/112; 358/406; 358/3.26

(57) ABSTRACT

A page reference system that facilitates identification of the locations of printing defects on a printed page includes a sheet of media with one or more reference points and, optionally, indicia printed thereon. The page reference system may be preprinted or printed along with another file. Accordingly, a page reference program that causes the page reference system to be printed onto a sheet is disclosed, as are systems that employ such a program. A method for using the page reference system includes printing a file onto a sheet of media onto which the page reference system is also printed, using the page reference system to identify the locations of one or more printing defects on the page, and diagnosing a printing device error responsible for each printing defect. The locations of one or more printing defects may be communicated to a product support representative, who then makes the diagnosis.

### BACKGROUND OF THE INVENTION

1. Field of the Invention

The present invention relates generally to methods and apparatus for providing points of reference for files that are printed on sheets of paper or other media. More specifically, the present invention relates to methods for using such points of reference in manually diagnosing the causes of printing defects that may occur as the files are printed onto the sheets.

2. Background of Related Art

Typically, printing is effected by providing a digital file to a printing device, such as a printer, facsimile machine, copy machine, or the like. A file to be printed may be accompanied by a so-called “packet”, which may include identifiers for the source device and the intended recipient device, and instructions as to how the file is to be printed (e.g., the number of copies, the type of paper or other sheets of media to be used, the orientation in which printing is to be effected on such sheets, etc.). Upon receiving such a file, along with its accompanying packet, a processor of a printing device may “read” the digital file and cause a printing component of the printing device to print the appropriate images (e.g., text, lines, graphics, fills, etc.) onto one or more sheets of media.

In addition to printing the desired text and/or other images, the printing component of a printing device may print other, undesirable elements onto one or more of the sheets of media. For example, spots, lines, streaks, bleeding, haloing, tenting (an undesired space between images or different elements of an image caused by the creation of a so-called “shadow” at the edge of a particular element of an image), trail-edge deletion and starvation, and other so-called “defects” or “imperfections” may appear on the one or more sheets upon which the desired images are printed.

Many printing defects are often caused by the printing component of a printing device rather than by the processor thereof and may be remedied by a user of the printer, provided appropriate software is available to the user or the user has been given proper instructions.

If the user of a printing device is unable to correct these defects by use of options that are available in the driver software for that printing device, he or she may contact a product support representative for help in remedying the printing defects. The user of the printing device may not, however, be able to adequately describe the locations, sizes, or types of defects that are occurring as a digital image is converted to a printed image by the printing device. Likewise, the user of the printing device may not understand or be able to quickly and clearly communicate to the product support representative whether or not the defect is the result of the image that is being printed or due to a malfunction of the printing device (e.g., repeating dots caused by a reel or fuser within the printing device).

When a product support representative asks questions of the user of a printing device regarding the printing problems that are occurring, such as the type of problem, the direction in which sheets are fed through the printing device, the orientation of the image on the sheet, etc., it is not infrequent for the user of the printing device to guess or speculate regarding an answer if he or she is not sure of the precise answer.

In other instances, the user of a printing device may provide a product support representative with a sample of the printing error (e.g., by mail, scanned and e-mailed image, etc.). Nonetheless, such a sample may lack information that the product support representative needs to properly respond to the printing problem at issue.

Accordingly, it appears that there is a need for a system that provides accepted, common reference points by which a user of a printing device may communicate information to a product support representative, as well as a method for generating such common reference points during use of a printing device that is causing defects.

### SUMMARY OF THE INVENTION

The present invention includes a method for providing points of reference on a printed page, as well as a printed page including such points of reference, a system using such a printed page, and a process for resolving printing defects by use of such a printed page.

Points of reference may be provided on a printed page in accordance with teachings of the present invention in a number of ways. By way of example, a software file comprising the reference points that correspond to a particular page orientation may be printed simultaneously with text and/or an image to be printed. As used herein, the term “image” applies to graphic images, as well as to lines, shapes, fills, and combinations thereof. The software file may be configured to form a so-called “watermark”, which is typically printed as a background to another printed image, or as a normal printed image to be superimposed relative to (i.e., over or under) another printed image.

A printed page according to the present invention may include a printed image and one or more reference points. By way of example only, the page may include a line grid, along with column and row identifiers. Accordingly, a user of the printing device can readily identify the location of a particular defect with respect to one or more boxes of the grid by determining the column and row in which each such box is located. In addition, the user of the printing device may be able to supply information as to the particular location of a defect within one or more boxes, as well as the size of the defect relative to the box or boxes in which it is located and the orientation of the defect relative to the box or the grid.

A user may cause a software file, which is also referred to herein as a “page reference program”, that encodes one or more points of reference that are to be printed to be supplied to a printing device (e.g., a printer, fax machine, copier, etc.) concurrently with the text and/or image to be printed. As an example of the manner in which a user of a printing device may cause reference points to be printed on a sheet along with an image, the user may select an option for printing such points of reference from a driver program for the problematic printing device. In another example, one or more desired text and/or image files may be printed simultaneously with reference points according to the present invention in the environment of a program that is specifically designed to cause such reference points to be printed. As another example, a product support representative may remotely access a user's computer or printer over the Internet or other telecommunications system and by way of a diagnostic program configured to provide such access and initiate printing of a test file and a particular set of reference points.

Another embodiment of page reference program may be in the form of stored software, firmware, or programmed hardware on a printing device. This type of page reference program may be executed by a processor of the printing device by providing the processor with an appropriate command.

When the points of reference are printed onto a sheet concurrently with an image, the orientations of one or more of the reference points may provide information about the orientation (e.g., feeding short edge first, long edge first, etc.) of the sheet as it passed through the printing device. In addition, or as another alternative, information identifying the type of printing device being used may be printed along with the points of reference. Such identifying information may be important since two devices may be referred to in a similar manner and possess only subtle differences.

As an alternative to printing reference points concurrently with the printing of text and/or an image onto a sheet, the user of a printing device may be provided with sheets of paper or other media that include points of reference at particular locations thereon, which sheets are referred to herein as “diagnostic paper”. Optionally, such diagnostic paper may correspond to a particular type of printer and may include preprinted information thereon about the type of printing device to which the diagnostic paper corresponds. When the user is having problems with the printing device that he or she would like to discuss with a product support representative, one or more sheets of such diagnostic paper may be used with a problematic printing device to print a desired image onto the paper. The points of reference that appear on the paper may then be used, along with the printed image, as the basis for discussing the printing problem or problems with a product support representative.

Once an image has been printed onto a sheet that also includes one or more points of reference according to the present invention, the user of a problematic printing device can discuss operation of the printing device and one or more printing defects with respect to the one or more points of reference. If the location indicia are also printed onto the sheet, the user may also describe the locations of printing defects with respect to such location indicia. Also, if such location indicia are printed onto the sheet, the user of a problematic printing device may explain the orientation of such location indicia to a product support representative, which explanation may provide the product support representative with more information pertinent to the cause or causes of the one or more printing defects that appear on the sheet. When the sheet includes information about the type of printing device being used, or device-identifying indicia, a user of the printing device may readily provide a product support representative with accurate information about the type of printing device having problems by referring to such identifying information.

Other features and advantages of the present invention will become apparent to those of ordinary skill in the art through a consideration of the ensuing description, the accompanying drawings, and the appended claims.

### BRIEF DESCRIPTION OF THE DRAWINGS

In the drawings, which illustrate exemplary embodiments of various aspects of the present invention:

FIG. 1 is a schematic representation of a first embodiment of page reference system according to the present invention;

FIG. 2 is a schematic representation of a second embodiment of page reference system according to the present invention;

FIG. 3 is a flow chart depicting an exemplary process flow of a method of the present invention;

FIG. 4 is a flow chart depicting an exemplary process flow for a computer-operated or workstation-operated diagnostic program incorporating teachings of the present invention;

FIG. 5 schematically depicts a printing device that includes programming to effect a diagnostic method according to the present invention;

FIG. 6 is a flow chart depicting an exemplary process flow for a printing device-operated diagnostic program according to the present invention;

FIG. 7 is a schematic representation of a third embodiment of page reference system of the present invention; and

FIG. 8 is a schematic representation of a fourth embodiment of page reference system of the present invention.

### DETAILED DESCRIPTION

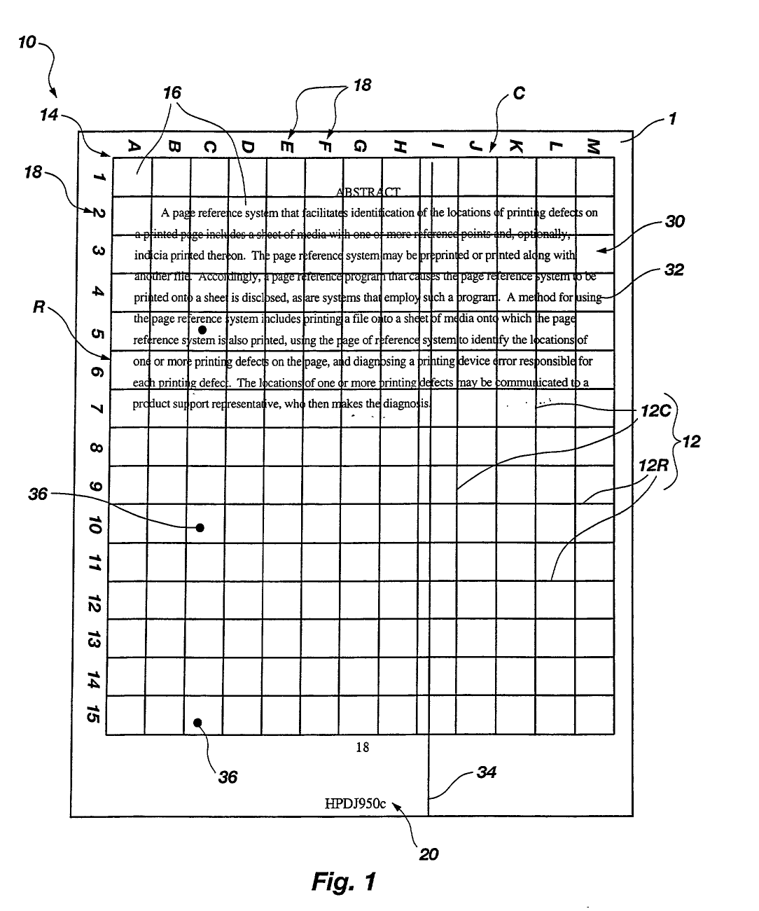

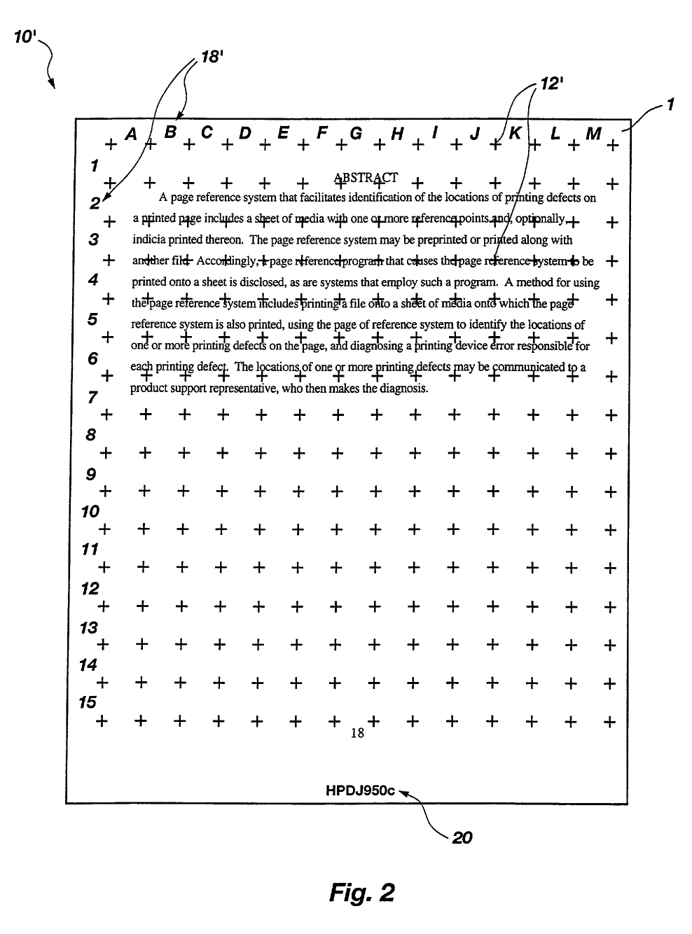

An exemplary embodiment of a page reference system 10 according to the present invention is illustrated in FIG. 1. As shown, page reference system 10 is printed onto a sheet 1, or page, of media, such as paper, card stock, acetate (e.g., for use with an overhead projector), or the like, upon which a printing device, such as a printer, facsimile machine, copy machine, or the like, has printed various text and/or images. One or more reference points 12, such as dots, lines, or symbols, form page reference system 10. In addition, page reference system 10 may include indicia 18 that correspond to various reference points 12, which may be referred to herein as “location indicia”, as well as one or more identifiers 20 (FIG. 2) for the type of printing device being used, which are also referred to herein as “device-identifying indicia”.

As depicted, sheet 1 includes an image 30 printed thereon in a so-called “portrait” orientation, with the short edges of sheet 1 comprising the top and bottom thereof and the long edges of sheet 1 comprising the sides thereof. Page reference system 10, which has also been printed onto sheet 1, includes series of mutually parallel row lines 12R and mutually parallel column lines 12C that are oriented perpendicularly relative to row lines 12R. Accordingly, row lines 12R and column lines 12C form a grid 14, with boxes 16 of grid 14 being formed between adjacent pairs of row lines 12R and column lines 12C. FIG. 1 shows that row lines 12R may be spaced equal distances apart from one another. Column lines 12C may also be spaced equal distances apart from one another, either the same distance as that between adjacent row lines 12R, as shown in FIG. 1, or a different distance than that between adjacent row lines 12R. As row lines 12R of the page reference system 10 depicted in FIG. 1 are spaced apart from one another the same distance that column lines 12C are spaced apart from each other, each box 16 of grid 14 is square in shape. The distance between adjacent column lines 12C, as well as that between adjacent row lines 12R, may be a known, calibrated length (e.g., ¼″, ½″, ¾″, 1″, 2″, 3″, etc.) so as to automatically provide a viewer with information about the dimensions of each box 16, as well as the distance a particular defect may be located from each edge of sheet 1.

Indicia 18 of the depicted, exemplary page reference system 10 comprise letters that correspond to each column C of boxes 16, which are positioned adjacent to their corresponding column C, and numbers that correspond to each row R of boxes 16, which are positioned adjacent to their corresponding row R. While image 30 appears on sheet 1 in a “portrait” orientation, indicia 18 have been printed with sheet 1 traveling in a long edge-first direction through the printer and, thus, indicia 18 may appear on sheet 1 in a sideways orientation. The orientation of indicia 18 on sheet 1 may reflect the orientation of sheet 1 as it traveled through a problematic printing device for which a diagnosis is sought, as well as identify the leading edge of sheet 1 as it traveled through the problematic printing device. In this case, the sideways orientation of indicia 18 relative to the portrait-oriented image 30 indicates that sheet 1 traveled through the problematic printing device long edge-first. This is evident because the edge of sheet 1 that appears at the top thereof when indicia 18 are placed in a horizontal, reading orientation, in this case the right edge of sheet 1, would have been the leading edge of sheet 1. The orientation of indicia 18, or additional indicia (not shown) may also indicate which edge (i.e., the top short edge, the bottom short edge, the left long edge, or the right long edge) of sheet 1 traveled through the printer first.

Image 30 comprises text 32 that appears in accordance with a user's desires, along with several defects, in this case a line 34 and several spots 36 that were not desired by the user of the printing device. As image 30 and page reference system 10 are superimposed, the position of each defect, such as a line 34 or spots 36, may be readily identified by referring to each of the boxes 16, which may be specified by column letter and row number or vice-versa, in which that defect occurs.

FIG. 2 depicts another exemplary embodiment of page reference system 10′ incorporating teachings of the present invention. The depicted page reference system 10′ includes a sheet 1, or page, of media onto which a printing device has printed various text and/or images. Among the images printed on sheet 1 are reference points 12′, which have the appearance of cross hairs. Reference points 12′ are arranged in a grid-like fashion, with the horizontal lines of laterally adjacent reference points 12′ being aligned and the vertical lines of longitudinally adjacent reference points 12′ also in alignment. As depicted, each reference point 12′ is spaced at equal distances from each vertically and horizontally adjacent reference point 12′, although the spacing between vertically adjacent reference points 12′ may be different from the spacing between horizontally adjacent reference points 12′.

Page reference system 10′ may also include indicia 18′ that correspond to various reference points 12′. As shown in FIG. 2, indicia 18′ may comprise numerals positioned adjacent to corresponding reference points 12′. Indicia 18′ may be oriented in such a way as to indicate the path that was traveled by sheet 1 through the problematic printing device.

An identifier 20 may be printed onto sheet 1 to identify the type of printing device being used to print text and/or images upon sheet 1.

A page reference system 10, 10′ according to the present invention may be provided as a computer program in the form of software that may accompany or be a part of a driver program, which is commonly referred to simply as a “driver”, for a printer, facsimile machine, copy machine, or the like, as a separate printer diagnostic program, in the form of software, firmware, or hardware that may be executed by the processor of a printing device. Such a program is referred to herein as a “page reference program”. Alternatively, all or part of a page reference system 10, 10′ of the present invention may be provided as a preprinted sheet that may or may not correspond to the type of printer for which diagnosis is desired.

While FIGS. 1 and 2 depict page reference systems 10, 10′ that include rows and columns with substantially equal widths, other configurations of page references systems, which may include rows or columns of different widths, are also within the scope of the present invention.

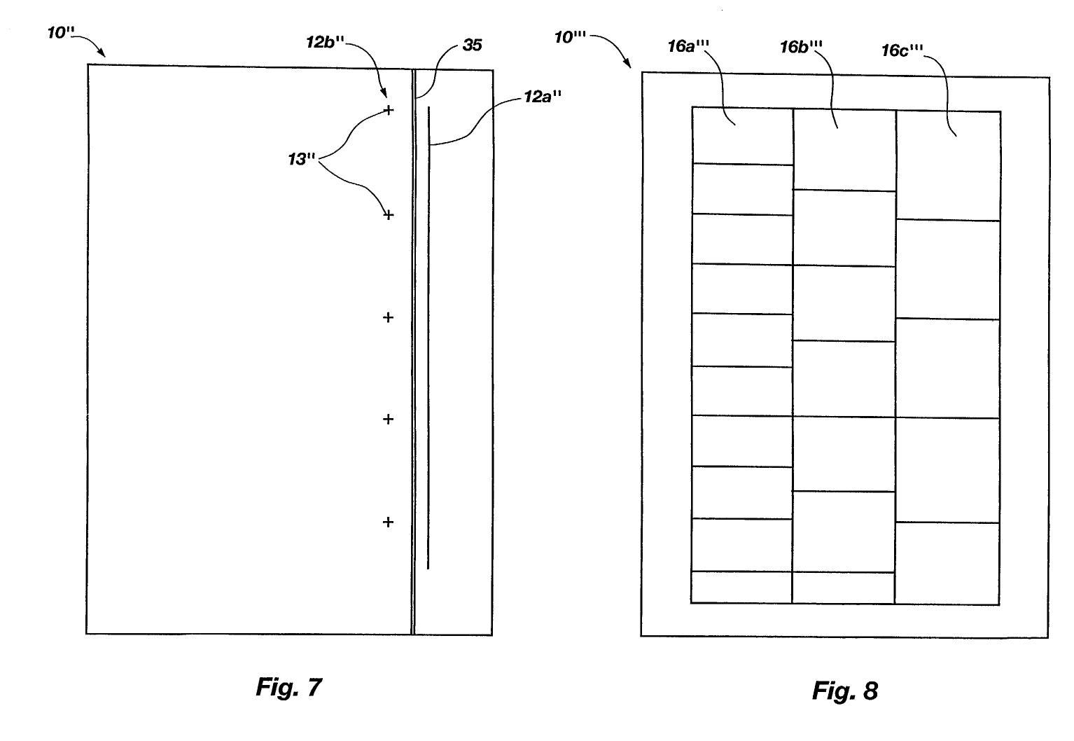

As another alternative, and with reference to FIG. 7, a page reference system 10″ incorporating teachings of the present invention may include a single line 12a″ or reference points 13″ that are arranged in a single line 12b″. By way of example only, the line 12″ or reference points 13″ of such an embodiment of page reference system could be positioned so as to align approximately with the position of a potentially problematic component of a printing device, such as a thermistor thereof. If a printing defect, such as a smudge 35, is roughly parallel to and within a predetermined distance (e.g., about one centimeter) of such a line 12a″, 12b″, a contaminated thermistor could be readily determined to be the cause of the printing defect. Of course, other defect-specific page reference systems are also within the scope of the present invention.

Also, a page reference system 10′″ incorporating teachings of the present invention may include adjacent columns or rows with boxes 16a′″, 16b′″, 16c′″, etc. of different sizes, as shown in FIG. 8. By way of example only, the heights of boxes 16a′″may be about 30 mm, while boxes 16b′″ of the next, adjacent column have heights of about 56 mm, and boxes 16c′″ are 65 mm high. These different heights may correspond to dimensions of different components of a problematic printer, such as the circumferences of different rollers.

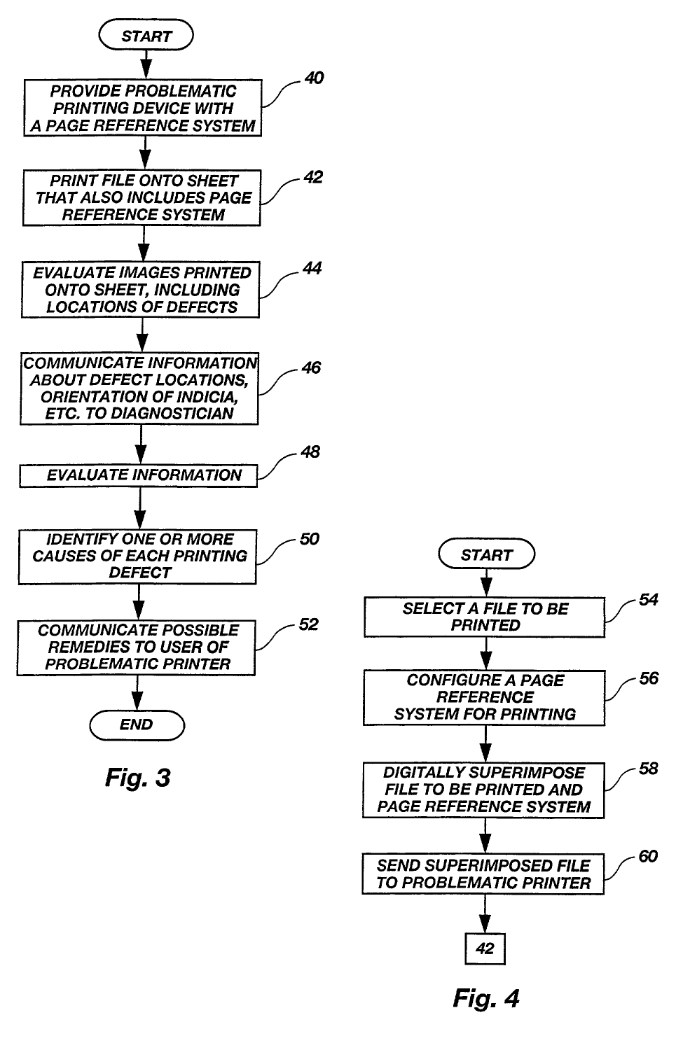

Turning now to the flow chart of FIG. 3, an exemplary method for diagnosing the cause of a printing defect in a problematic printing device is illustrated. At reference character 40, a page reference system 10, 10′ (FIGS. 1 and 2) is provided to the problematic printing device along with a file, in the form of a text and/or images, to be printed.

Referring again to FIGS. 1, 2, 7, and 8 page reference system 10, 10′, 10″, 10′″ may be provided to the problematic printing device in a number of different ways. For example, a preprinted sheet 1 of a page reference system 10, 10′, 10″, 10′″ may be placed in a sheet intake portion (e.g., a drawer, receptacle, etc.) of the problematic printing device.

As another example of the manner in which a page reference system 10, 10′, 10″, 10′″ of the present invention may be provided to a processor of the problematic printing device, data embodied in a carrier wave (e.g, an electrical signal conveyed along a wire or cable, an electromagnetic signal carried along a fiber optic line, a wireless electromagnetic signal, etc.) may be transmitted to the processor of the problematic printer to instruct the processor to cause a printing component of the problematic printer to print a visible version of page reference system 10, 10′, 10″, 10′″ onto a sheet 1. The page reference system data may be sent to the printer substantially concurrently with data that corresponds to a file (e.g., text and/or images) to be printed onto sheet 1, which file is also referred to herein as a “selected file”.

Upon receiving data corresponding to a file to be printed and the page reference system data, the processor of the problematic printer may print the appropriate images, including reference points 12, 12′ and any indicia 18, onto sheet 1. Page reference system 10, 10′, 10″, 10′″ may then be printed onto sheet 1 either as a watermark, as solid images, or as a combination thereof, and superimposed with a selected file. The manner in which page reference system 10, 10′, 10″, 10′″ is printed may be predetermined, automatically determined, or set by a user of the problematic printer (e.g., by use of options provided in printer driver software or another page reference system 10, 10′, 10″, 10′″-generating program).

If page reference system 10, 10′, 10″, 10′″ is printed as a watermark, it may appear lighter than the printed images that correspond to the data of the selected file and may be printed without substantially altering the appearance of the selected file at locations where the selected file and page reference system 10, 10′, 10″, 10′″ overlap one another.

If, in the alternative, page reference system 10, 10′, 10″, 10′″ and the selected file are printed as superimposed files, either page reference system 10, 10′, 10″, 10′″ or the selected file may take precedence in locations at which portions of page reference system 10, 10′, 10″, 10′″ and the selected file overlap one another, with the printed elements of the file taking precedence in appearing on sheet 1 and masking “underlying” elements of the other of the selected file and page reference system 10,10′ at the overlapping locations.

Page reference systems 10, 10′, 10″, 10′″ that include combinations of watermark type elements and solid elements are also within the scope of the present invention. By way of example only, reference points 12, 12′ could be printed more lightly (e.g., as a watermark) than the text or images are printed onto sheet 1, while indicia 18, 18′ may have a more visible, solid appearance.

A page reference system according to the present invention, such as page reference system 10, 10′, 10″, or 10′″, may be provided to a problematic printer as a preprinted sheet, by way of the user of a problematic printer selecting an appropriate option on printer driver software, when the user of a problematic printer or a product support representative with access to the user's computer, as known in the art, causes a page reference system-generating program (i. e., software) on the user's computer to be executed, or by the user of a problematic printer causing the problematic printer to execute a program stored on the printer (e.g., in the form of firmware, programmed or programmable hardware, etc.).

If the printed page reference system 10, 10′, 10″, 10′″ is generated by a diagnostic program on the user's computer, as illustrated by the flow chart of FIG. 4, the diagnostic program may require the user or permit a product support representative with access thereto to select a file to be printed, at reference character 54 of FIG. 4, and to configure page reference system 10, 10′, 10″, 10′″ (FIGS. 1, 2, 7, and 8) to be printed onto a sheet 1 with the selected file, at reference character 56 of FIG. 4. The diagnostic program may then, at reference character 58 of FIG. 4, digitally “superimpose” the file to be printed and page reference system 10, 10′, 10″, 10′″. This combined file may then be sent to the problematic printer, at reference character 60 of FIG. 4.

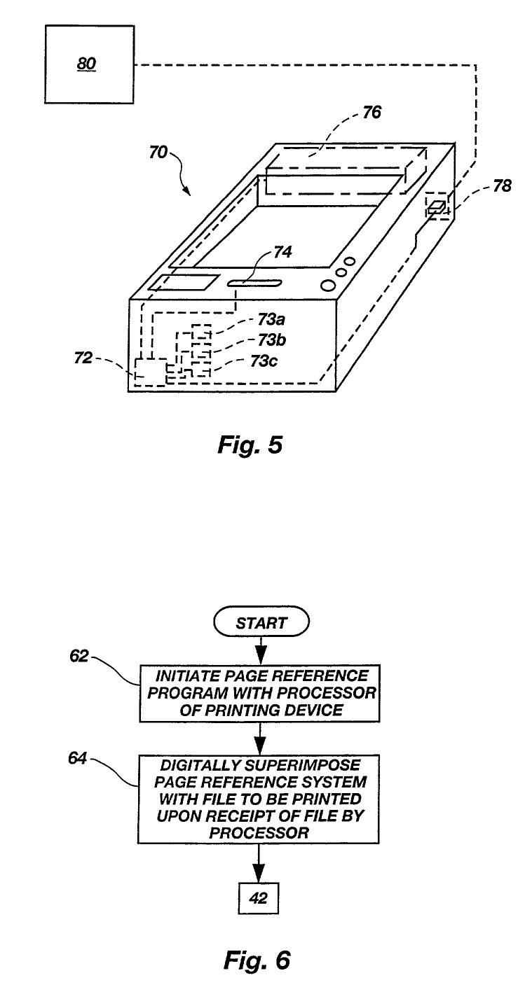

Alternatively, with additional reference to FIG. 5, a page reference system 10, 10′, 10″, 10′″ according to the present invention may be generated by a page reference program that resides on a printing device 70, such as in memory 73a, firmware 73b, or programmed or programmable hardware 73c thereof. FIG. 5 schematically depicts a printing device 70 that includes or may be programmed to include a page reference program according to the present invention. The use of such a program is illustrated in the flow chart of FIG. 6. The page reference program may be retrieved and initiated by a processor 72 of printing device 70, at reference character 62 of FIG. 6, by providing processor 72 of printing device 70 with an appropriate command. Such a command may be provided to processor 72 from a computer 80 in communication therewith (e.g., through a communication element 78 of printing device 70) or by entering a command directly into an input element 74 of printing device 70, such as by depressing the depicted button. Upon receipt of a packet that includes a file to be printed by processor 72, the page reference program may cause processor 72 to at least partially digitally superimpose the file to be printed and a page reference system 10, 10′, as shown at reference character 64 of FIG. 6.

Returning reference to FIGS. 1 through 3, at reference character 42 of FIG. 3, the processor (e.g., processor 72 in FIG. 5) of the problematic printing device (e.g., printing device 70 in FIG. 5) may cause the selected file to be printed onto sheet 1 (FIGS. 1 and 2) by a printing component (e.g., printing component 76 depicted in FIG. 5) of the problematic printing device, as known in the art. If page reference system 10, 10′ (FIGS. 1 and 2) is supplied to the problematic printer as data, page reference system 10, 10′ may be printed onto sheet 1 substantially simultaneously with the selected data or separately therefrom by causing sheet 1 to be reintroduced through the problematic printing device.

Alternatively, if page reference system 10, 10′, 10″, 10′″ is printed onto a sheet 1 of transparent media, such as acetate, page reference system 10, 10′, 10″, 10′″ may be printed separately from printing, at reference character 42, of another file and superimposed thereover to evaluate any printing defects. As another alternative, page reference system 10, 10′, 10″, 10′″ may be separately printed onto a sheet 1 of paper or other opaque media, then subsequently used like a ruler relative to a sheet 1 on which a file has been printed and on which one or more printing defects occur. Of course, printing of page reference system 10, 10′, 10″, 10′″ may be effected with the problematic printer or with another printing device.

Next, at reference character 44 of FIG. 3, the user of the problematic printer evaluates the images printed onto sheet 1 and locates any defects, such as the lines 34 and spots 36 depicted in FIG. 1. In addition, the user may identify the location of each defect with respect to one or more reference points 12, 12′ (FIGS. 1 and 2) and accompanying indicia 18, 18′ of page reference system 10, 10′, 10″, 10′″.

The user of the problematic printer may then take remedial action on his or her own, preferably in reliance upon a corresponding trouble shooting guide associated with the particular model of printer being used. Alternatively, the reference grid file may itself include remedial instructions. By way of example only, a text string, such as “Clean the thermistor if a linear smudge appears in column J.” could be printed somewhere on the page.

Alternatively, descriptions of the defects and their respective locations on sheet 1 may then be communicated to a product support representative or other diagnostician, as indicated at reference character 46 of FIG. 3. By way of example only, these descriptions may be provided to the product support representative orally (e.g., over the telephone), by written description (e.g., by e-mail, text messaging, etc.), or visually (e.g., by electronic transmittal of a scanned file, by mail, etc.).

The product support representative may then evaluate one or more of the defects, patterns of defects, and repetition of defects at reference character 48 of FIG. 3 and, based upon such evaluation, identify one or more possible causes of each type of defect, at reference character 50 of FIG. 3. Possible remedies for each type of printing defect, if available, may then be communicated to the user of the problematic printer, at reference character 52 of FIG. 3.

By way of example only, and referring again to FIG. 1, lines 12R of page reference system 10 may be positioned a uniform distance (e.g., about 30 mm) apart from one another that corresponds to a circumference of a roller of the defective printer. The occurrence of spots 36 at substantially equal distances from each line 12R (e.g., 5 mm, 10 mm, 15 mm, etc.) of page reference system 10 may indicate that the roller was responsible for spots 36. If, however, spots 36 appear at differing distances from each line 12R (e.g., 5 mm from one grid line and 10 mm from the next grid line), it can be concluded that the roller is not responsible for the appearance of spots 36.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. Additions, deletions, and modifications to the invention, as disclosed herein, which fall within the meaning and scope of the claims are to be embraced thereby.

What is claimed is:

1. A system for diagnosing printing defects, comprising:
at least one sheet of media configured to receive print of at least one of text and images; and
reference points printed onto said at least one sheet for identification of a location of at least one printing defect.

2. The system of claim 1, further comprising at least one indicium on said sheet.

3. The system of claim 2, wherein said at least one indicium comprises at least one location indicium.

4. The system of claim 3, wherein said at least one location indicium includes at least one indicium oriented upon said at least one sheet in a manner indicative of a path said at least one sheet has traveled through a printing device.

5. The system of claim 3, comprising a plurality of location indicia.

6. The system of claim 5, wherein each location idicium of said plurality of location indicia at least partially corresponds to at least one of said reference points.

7. The system of claim 2, wherein said at least one indicium comprises a device-identifying indicia.

8. The system of claim 1, wherein said reference points include reference points in an array.

9. The system of claim 1, wherein said reference points include reference points preprinted onto said at least one sheet.

10. The system of claim 1, wherein said reference points include reference points printed onto said at least one sheet substantially concurrently with said print.

11. The system of claim 1, further comprising:
a printing device for which diagnosis is desired.

12. A method for diagnosing at least one printing defect, comprising:
providing a sheet of media to a printing device for which diagnosis is desired;
printing at least one of text and images onto said sheet, said sheet also including reference points printed thereon; and
identifying a location of the at least one printing defect on said sheet relative to at least one of said reference points.

13. The method of claim 12, wherein said providing comprises providing said sheet with said reference points preprinted thereon.

14. The method of claim 12, wherein said printing comprises printing said reference points onto said sheet.

15. The method of claim 14, wherein said printing said reference points onto said sheet comprises:
transmitting data for said reference points to a processor of said printing device.

16. The method of claim 15, wherein said transmitting is effected by a processor of a computer in communication with said printing device in response to a command provided by a printer driver stored in memory associated with said processor of said computer.

17. The method of claim 15, wherein said transmitting is effected by a processor of a computer in communication with said printing device in response to a command provided by a diagnostic program stored in memory associated with said processor of said computer.

18. The method of claim 15, wherein said transmitting is effected by said processor of said printing device in response to a command provided to said processor.

19. The method of claim 14, wherein said printing said reference points onto said sheet is effected substantially concurrently with said printing at least one of said text and said images.

20. The method of claim 12, wherein said identifying said location comprises identifying a characteristic of the at least one printing defect.

21. The method of claim 12, further comprising:
communicating at least said location to a diagnostician.

22. The method of claim 12, further comprising:
making a diagnosis based on at least said location of the at least one printing defect.

23. The method of claim 22, further comprising:
providing at least one possible solution for the at least one printing defect based on said diagnosis.

24. A printing system, comprising:
a printing device including a processor, a communication element in communication with said processor, and a printing component in communication with said processor;
a page reference program for causing said processor to effect printing by said printing component of a page reference system and a file to be printed upon at least one same sheet of media.

25. The printing system of claim 24, wherein said page reference program includes one of a page reference system stored on memory of a computer that communicates with said processor of said printing device through said communication element and executed by a processor of said computer, a page reference program executed by said processor of said printing device, which instructs said printing component to print said page reference system on a sheet of media upon receipt of a file to be printed by said processor of said printing device through said communication element, and a page reference program comprising at least one of software stored on memory media configured to communicate with said processor of said printing device, firmware configured to communicate with said processor of said printing device, and programmed or programmable hardware configured to communicate with said processor of said printing device.
